(19) United States
(12) Patent Application Publication
(10) Pub. No.: US 2004/0142181 A1
(43) Pub. Date: Jul. 22, 2004

(54) PTFE/polyphenylene sulphide bearing material and method of manufacture

(76) Inventors: Derek Marsella, Jackton by East Kilbride (GB); Janette Johnston, Kilmarnock (GB)

Correspondence Address: John M. Harrington, Kilpatrick Stockton LLP, 1001 West Fourth Street, Winston-Salem, NC, 27101, US

(21) Appl. No.: 10/345,576

(22) Filed: Jan. 16, 2003

(51) Int. Cl. B32B 27/18

(52) U.S. Cl. 428/421; 384/908

(57) ABSTRACT

A bearing material and a method for the production thereof are described. The bearing material comprising a matrix of polytetrafluoroethylene (PTFE) having dispersed therein in 10 to 30 volume % polyphenylene sulphide. The method of making a PTFE/PPS bearing material comprises the steps of mixing an aqueous dispersion of polytetrafluoroethylene with 10 to 30 volume % of an aqueous dispersion of polyphenylene sulphide, co-coagulating the PTFE and PPS; removing excess water; at least partially drying the wet co-coagulated material to provide an at least partially dried powder material; spreading said at least partially dried powder material particles onto a substrate to form a bearing material layer; compacting said layer; drying said compacted layer to drive off residual liquid; and, sintering said dried, compacted layer at a temperature above the melting point of said PTFE constituent.

### FIELD OF THE INVENTION

The present invention relates to a plastics based bearing material and a method for making a plastics based bearing material. More precisely, the present invention relates to a bearing material comprising polytetrafluoroethylene and polyphenylene sulphide. This material is then applied to a strong backing material to form bearings.

### BACKGROUND OF THE INVENTION

Many different types of plastics based bearing materials comprising a plastics matrix, and having various fillers, and applied to a strong backing material such as steel having a porous bonding interlayer composed of bronze particles sintered to the steel, are known. One such material comprises polytetrafluoroethylene (PTFE) having therein lead particles, the material being impregnated into the porous bronze interlayer described above to leave a thin layer, generally less than 25 μm, above the upper surface of the bronze interlayer. The material is made by mixing an aqueous dispersion of the PTFE with the filler material together with an organic lubricant such as toluene; coagulating the dispersion to form a so-called “mush” and decanting off the water; spreading the wet mush on the backing material; applying pressure to the mush so as to impregnate the mush into the porous layer; heating to drive off the residual water and lubricant; and, finally heating the material at a temperature above the melting point of the PTFE to sinter the PTFE particles together. The need to drive off the residual water limits the thickness of the layer which may be formed above the porous interlayer due to the resultant blistering which occurs when thicker layers are attempted. However, even when the surface layer is limited to the generally accepted 25 μm or so, microscopic examination of the sintered bearing material reveals porosity in the bearing material itself.

Generally, such porosity does not normally matter in most engineering applications for which this type of material is used since the load application is usually static, i.e. applied in one direction, and at loads well within the capability of the material to withstand. More recently such plastics bearings have been used in engineering applications where the load is dynamic, i.e. the load application direction constantly changes and the load applied to the axial length of a generally cylindrical bearing bush is non-uniform in that edge-loading at the ends of the bush occurs. One such application is in hydraulic gear pumps, which are used in many different applications including automotive vehicles. With the increasing complexity and sophistication of all types of vehicles, such gear pumps may be used in many different applications in one vehicle and may include, for example; lubricating oil pumps for engines, coolant pumps, power steering pumps and many more.

The construction of such pumps generally comprises two intermeshing gears which are each supported on stub shafts at each axial end, the stub shafts themselves being supported in bearing bushes of the type described above which are held in a housing forming the body of the fluid pump. Plastics bearing materials used in these applications have been failing. The mode of failure appears to be due to the fact that the oil, for example, being pumped between the meshing gear teeth exerts a high load tending to push the gears away from each other and thus causing bending and deflection of the supporting stub shafts in their supporting bearing bushes causing side-edge loading at the bush ends. The result of this deflection induced loading is to cause some of the bearing material per se to creep over the chamfer on the end face at the point of greatest loading and a crack is initiated adjacent the chamfered edge. The crack then propagates into the bearing bush bore due to the oil pressure differential between the ends of the bearing bush. Oil under pressure then washes through the crack so formed and erosion of the bearing lining occurs. The cause of the initial creeping of the polymer material over the chamfered end edge has been identified as a lack of sufficient strength in the lining material itself, due in part to the porosity present in the plastics lining material.

An improved bearing material in this particular application of gear pumps is described in GB-B-2 196 876. The material described comprises tetrafluoroethylene resin and tetrafluoroethylene-hexafluoropropylene copolymer and/or tetrafluoroethylene-perfluoroalkylvinylether copolymer with a filler of lead-tin metal alloy, the material being impregnated into a porous bronze sintered interlayer on steel as described above. While this material constitutes a distinct improvement over other known materials in gear pump applications, it suffers from the disadvantage that it contains lead which is ecologically undesirable especially when the time comes for engines and components utilizing lead containing bearings to be scrapped.

### SUMMARY OF THE INVENTION

The present invention relates to a method for the manufacture of a bearing material, the method comprising the steps of mixing an aqueous dispersion of polytetrafluoroethylene with about 10 to about 30 volume % of a polyarylene sulphide, co-coagulating the PTFE and the PAS, removing excess water; at least partially drying the wet co-coagulated material to provide an at least partially dried powder material, spreading said at least partially dried powder material particles onto a substrate to form a bearing material layer, compacting said layer, drying said compacted layer to drive off residual liquid, and sintering said dried, compacted layer at a temperature above the melting point of said PTFE constituent.

The present invention also relates to a plastics based bearing material obtainable by the method described above comprising a matrix of polytetrafluoroethylene having dispersed therein 10 to 30 volume % of a polyarylene sulphide.

The present invention also relates to a bearing comprising the bearing material described above impregnated into a porous layer of sintered bronze particles.

It is an object of the present invention to provide a bearing material having improved flow and cavitation erosion resistance and wear and fatigue resistance and chemical resistance while retaining low friction properties comparable with existing materials and to avoid the use of lead.

It is also an objective to provide a method of making a bearing material having improved flow, cavitation erosion resistance, wear, fatigue, and chemical resistance and providing such a bearing material in a thickness of between 25 and 100 μm with substantially less porosity and fewer micro-laminations in the finished material.

It is a further objective to provide such a bearing material which is free from lead.

It is a further objective to provide a bearing incorporating the bearing material disclosed herein.

### BRIEF DESCRIPTION OF THE DRAWINGS

FIG. 1 shows a schematic showing the steps of a manufacturing process for a bearing material according to the present invention;

FIG. 2 shows a schematic view of a fatigue test apparatus used to produce the results shown in FIG. 3

FIG. 3 is a bar chart showing relative fatigue resistance of a material according to an embodiment of the present invention as compared with other known materials;

FIG. 4 shows a schematic view of a wear test apparatus used to produce the results shown in FIG. 5.

FIG. 5 is a bar chart showing relative lubricated wear resistance of a material according to an embodiment of the present invention as compared with other known materials.

FIG. 6 is a bar chart showing relative corrosion resistance of a material according to an embodiment of the present invention as compared with other known materials.

### DETAILED DESCRIPTION

Throughout the specification and claims the constituents of the various embodiments of the present invention are expressed as volume percent in the final bearing material unless otherwise indicated.

According to a first preferred aspect of the present invention, there is provided a bearing material comprising a matrix of polytetrafluoroethylene having dispersed therein in about 10 to about 30 volume percent polyphenylene sulphide.

According to a second aspect of the present invention, there is provided a bearing material comprising a matrix of PTFE having dispersed therein in about 10 to about 30 volume percent of a polyarylene sulphide.

In one embodiment of the present invention, the polyarylene sulphide resin used may be a polymer made by the method disclosed in U.S. Pat. No. 3,354,129 but in general can be represented as a polymer including a recurring unit of the formula:

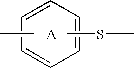

in which the ring A may be substituted.

One such form of substitution is represented by the formula:

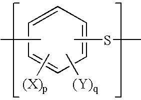

in which:

X represents a fluorine, chlorine, bromine or iodine atom, preferably chlorine or bromine, and Y represents a hydrogen atom,

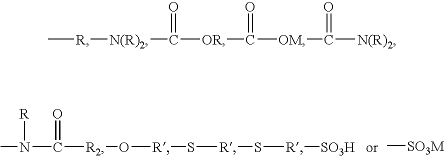

groups in which:

R represents a hydrogen atom, an alkyl, cycloalkyl, aryl, aralkyl, or alkaryl group containing 1 to 12 carbon atoms and in which:

M represents an alkali metal atom of a sodium or potassium atom and in which:

p is 0 to 4 and q is 2 to 4.

In another embodiment of the present invention, the bearing material comprises a mixture of two or more of the aforementioned polyarylene sulphides.

Preferred polyarylene sulphides for use in the present invention comprise those that are able to withstand the processing temperature of PTFE during the sintering step of the process. Further, preferred polyarylene sulphides comprise a particle size of less than 20 microns, however the particle size may be greater depending on the desired thickness of the final bearing material.

The preferred polyarylene sulphide for use in the present invention is polyphenylene sulphide in which the repeat unit can be represented by the formula:

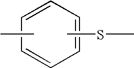

In a preferred embodiment of the present invention, the polyarylene sulphide is present in the final bearing material in an amount from about 15 to about 25 volume percent. In a most preferred embodiment of the present invention, the final bearing material comprises about 20 volume percent polyarylene sulphide.

In another aspect of the present invention, other polymeric fillers may be used in addition to, or in place of the polyarylene sulphide. Suitable polymeric fillers for use in the present invention must be able to withstand the processing temperature of PTFE and be available in granular form with a particle size of less than 20microns. The particle size is limited by the thickness of the desired layer of bearing material. Examples of suitable polymeric fillers include, fluorinated polymers such as polyvinylidenefluoride (PVDF) and ethylenechlorotrifluoroethylene (ECTFE), as well as engineering polymers such as polyetheretherketone (PEEK), polyimide (PI) and polyamideimide (PAI).

In another aspect of the present invention, there is provided a method for the manufacture of a bearing material, the method comprising the steps of: mixing an aqueous dispersion of polytetrafluoroethylene with 10 to 30 volume % of a polyarylene sulphide; co-coagulating the PTFE and the PAS; removing excess water; at least partially drying the wet co-coagulated material; spreading said at least partially dried material particles onto a substrate to form a bearing material layer; compacting said layer; drying said compacted layer to drive off residual liquid; and, sintering said dried, compacted layer at a temperature above the melting point of said PTFE constituent. A similar method is described in U.S. Pat. No. 6,461,679 to McMeekin et al., the disclosure of which is herein incorporated by reference.

After decanting off the excess water, the wet, coagulated material must be at least partially dried to remove the bulk of the remaining water. In another embodiment of the present invention, some water may be left in the resulting coagulated material which acts as a lubricant to the constituent powder particles during spreading and compaction onto the substrate. In yet another embodiment of the present invention, preferably, a small amount of additional lubricant is added to ensure acceptable spreading and compaction properties. The preferred lubricant for use in the present invention are hydrocarbon liquids.

In a further embodiment of the present invention, the coagulated material may be substantially completely dried and a separate lubricant liquid such as a hydrocarbon added to lubricate the dried powder particles in the spreading and compaction steps.

In the above method of the present invention, the content ranges given for the constituents of the bearing material are to be construed as those ranges existing in the final bearing material after sintering, in volume percent.

In a preferred embodiment of the present invention, the substrate on which the powder and lubricant mixture is spread may be a metal strip on which is provided a porous layer into which the spread layer is impregnated. The porous layer may be bronze particles sintered to a metal backing such as steel, for example, as is known in the art. In this way a strip bearing material may be formed from which cylindrical or semi-cylindrical bearings, for example, may be produced by known methods.

The partially dried powder or powder and lubricant mixture may be compacted or impregnated into the porous layer by means of a compacting rolling mill for example.

The metal backed bearing material so formed may be given a final size rolling operation to produce a material having an accurate wall thickness.

A particular advantage of the bearing material of the present invention is that it has significantly less porosity due to the fact that the majority of the water from the initial aqueous dispersions is purposely removed at an early stage in the process and in any event prior to compaction into a substantially solid form. Furthermore, the constituent materials have purposely been selected to be hydrophobic in nature to ensure the coagulated powder is free of wetting agents. In fact, after coagulation powder particles may be observed floating on the surface of the liquid due to their hydrophobic and low density. Thus, after compaction, only a relatively small amount of water and/or the relatively much more volatile lubricant need be removed and which causes no porosity and importantly allows the formation of a substantially thicker surface layer of up to about 100 μm above the porous bonding layer with no blistering. As a direct consequence of the method of the present invention, a plastics bearing lining may be produced which is boreable to allow accurate sizing by machining. Conventional mush route materials blister when surface layers of more than 40 μm are attempted.

The powder after at least partial drying comprises particles containing the aforesaid constituents of the bearing material in substantially homogeneous distribution.

In another embodiment of the present invention, instead of spreading the powder onto a substrate, the mixture may for example be extruded to from a monolithic tape or strip which may be dried and sintered as described above.

In a further embodiment of the method of the present invention, all constituents of the material are preferably mixed together simultaneously prior to co-coagulation. It has been found that simultaneous mixing of all components produces more homogeneous granules of the powder.

### EXAMPLES

In order that the present invention may be more fully understood, an example will now be described by way of illustration only, with reference to the accompanying drawings.

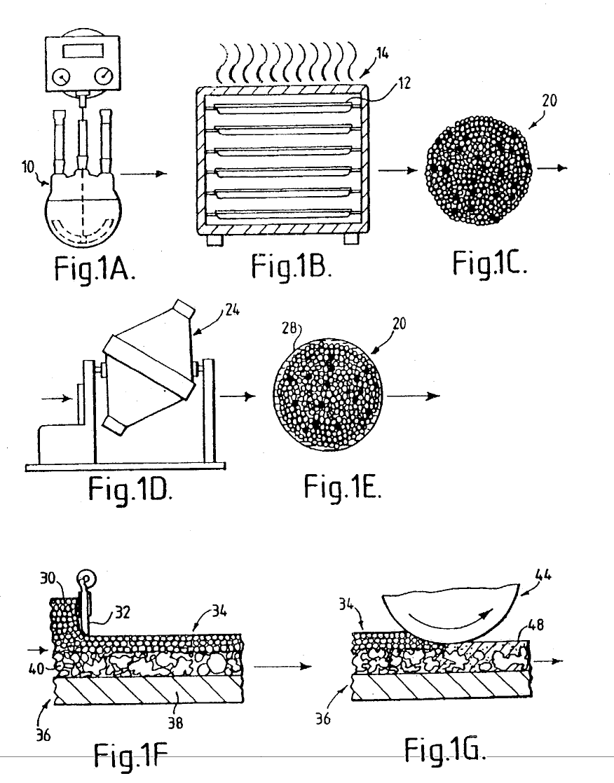

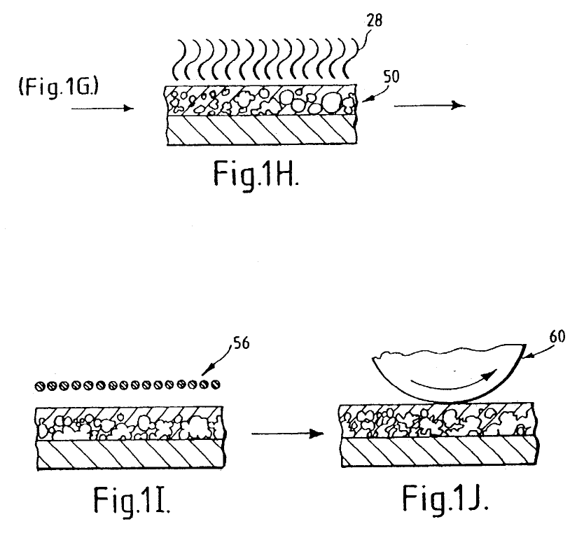

Referring now to FIG. 1 which shows schematically the production steps in the manufacture of a bearing material according to the present invention, the material having a final sintered composition of: PTFE and 25 volume % PPS.

An aqueous dispersion of unstabilised PTFE was mixed with the appropriate quantity of an aqueous dispersion of PPS in a stirring mixer 10 (Step A). The turbulence in the mixer causes the PTFE and the PPS to come into contact, the PTFE particles sticking together and increasing in size and taking the PPS particles with them to result in co-coagulation. Excess water was drained off the co-coagulated material and the wet solid was transferred to trays 12 in a drying oven 14 (Step B). This results in a dry powder comprising particles 20 which include all of the mix constituents (Step C). The dried powder is then mixed with a hydrocarbon lubricant in a mixer 24 (Step D). This results in a powder comprising the particles 20 having the lubricant 28 absorbed onto the surface of the powder particles and into the interstices of the particles (Step E). The powder/lubricant mixture 30 is then transferred to a spreading die 32 to deposit a layer 34 of predetermined thickness onto a substrate 36. The substrate 36 comprises a steel backing 38 having a known porous layer 40 of sintered bronze particles thereon (Step F). The substrate 36 and layer 34 is then passed through a rolling mill 44 which causes the layer 34 to be both compacted and also to be impregnated into the porosity of the layer 40 to leave a thin layer 48 above the bronze surface (Step G). The impregnated strip 50 is then heated gently by passing through a drying oven (not shown) to drive off the lubricant 28 (Step H). The dried strip 50 is then passed through a sintering oven 56 for a short duration at a temperature greater than 350° C. to cure the matrix material, such as through an induction heating oven for example (Step I). The thus sintered strip is then passed through a second rolling mill 60 to effect a size rolling operation to the strip 50 to produce an accurate overall wall thickness (Step J).

The PTFE/PPS material according to the present invention was tested against the following known bearing materials:

(1) DP4 which is a commonly used bearing material comprising PTFE with 19 volume % CaF2, 2 volume % filibrated Kevlar (trade name).

(2) RB99E, which is a commonly used bearing material comprising PTFE with 5 volume % monofluoroalkoxy, 19 volume % calcium fluoride, and 2 volume % alumina.

(3) DU, which is a commonly used bearing material comprising PTFE with 20 volume % lead.

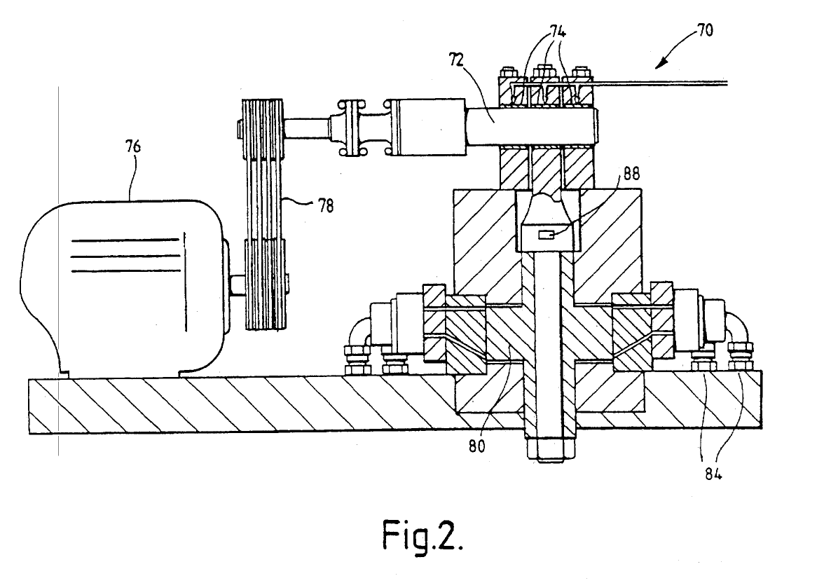

The strip material 50 so produced was formed into bearing bushes and tested on a known test apparatus 70 as shown in FIG. 2. The test apparatus 70 comprises a test shaft 72 running in bearings 74 to be tested and driven by an electric motor 76 via vee-belts 78. Load is applied to the bearings 74 by a load cylinder 80 to which the actual load is applied hydraulically by a pump (not shown) via control valves 84. Load at the bearings is measured by strain gauges 88.

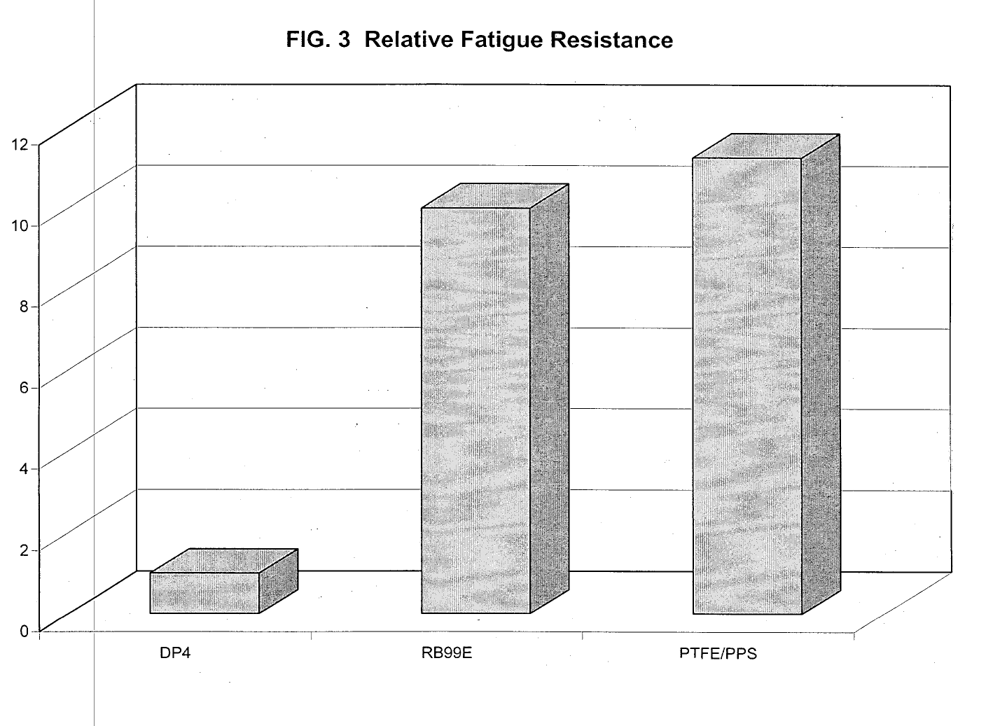

Bearing fatigue and wear characteristics under a simulated gear pump cycle comprising a high frequency dynamic load (e.g. greater than 100 Mpa at 50 Hz with surface rubbing speed of 4.81 m/s) is evaluated using the test rig design as shown in FIG. 2. Isolating the fatigue strength, as in FIG. 3, can be achieved using similar load conditions with no shaft rotation. Degree of fatigue was assessed by comparison with known standards.

As may be seen from FIG. 3, the relative fatigue resistance of the inventive material, PTFE/PPS, was shown to be substantially better than material RB99E and about 10 times better than material DP4.

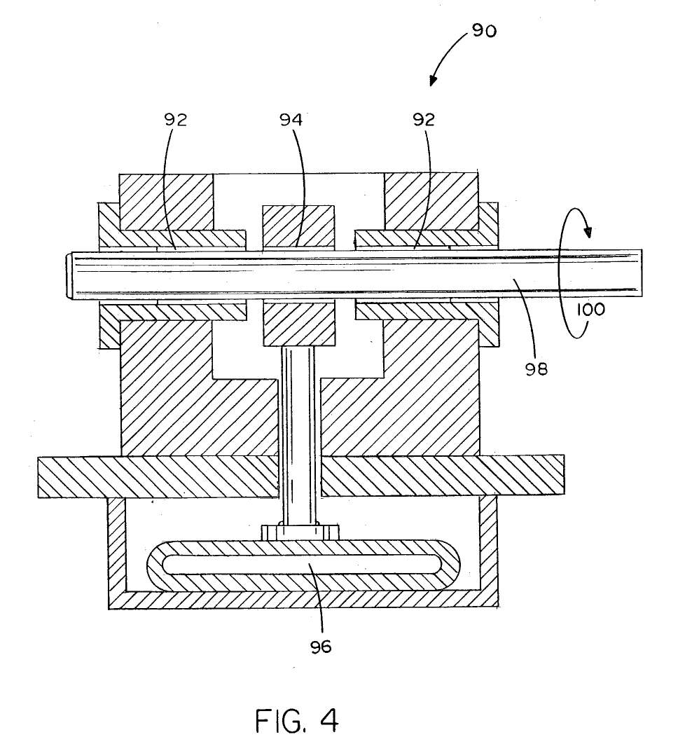

FIG. 4 shows a wear test rig 90 used to measure lubricated wear resistance. Test bushes 94 are tested against a variable unidirectional rotating 100 steel shaft 98. The shaft 98 is held in place through slave bearings 92 for the duration of the test. The load on the test material 94 is adjusted through the pneumatic diaphragm 96.

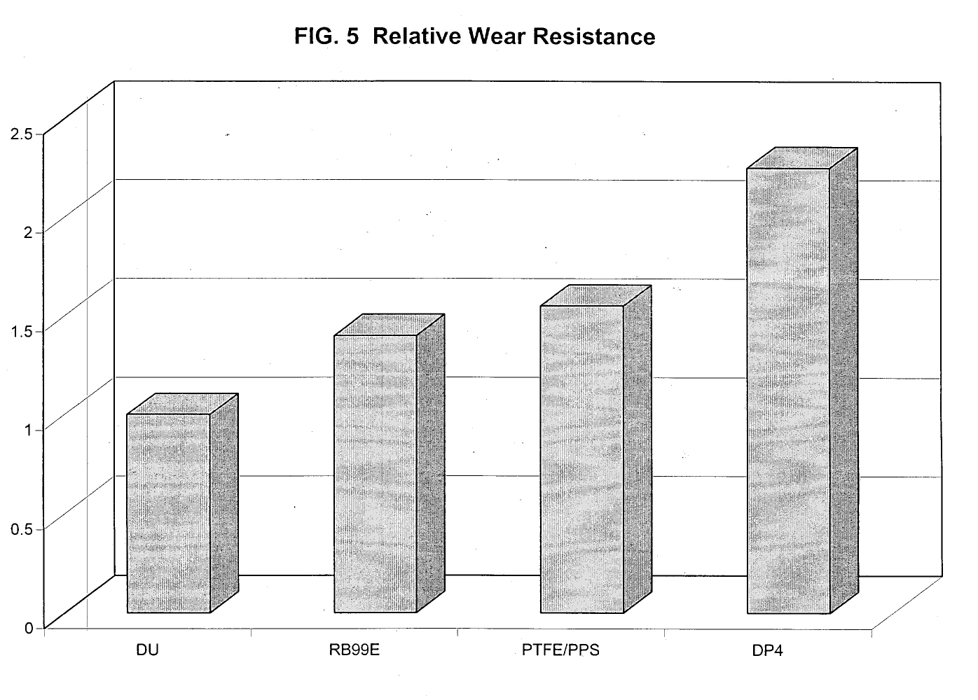

The operating conditions for the lubricated wear resistance test were as follows: the shaft speed was 0.114 m/s and the materials were tested under loads of 24.6, 36.8 and 49.2 MPa. FIG. 5 shows the relative lubricated wear resistance for the PTFE/PPS material of the present invention as compared to three common bearing materials. As can be seen, the material of the present invention showed better wear resistance than two of the three known samples.

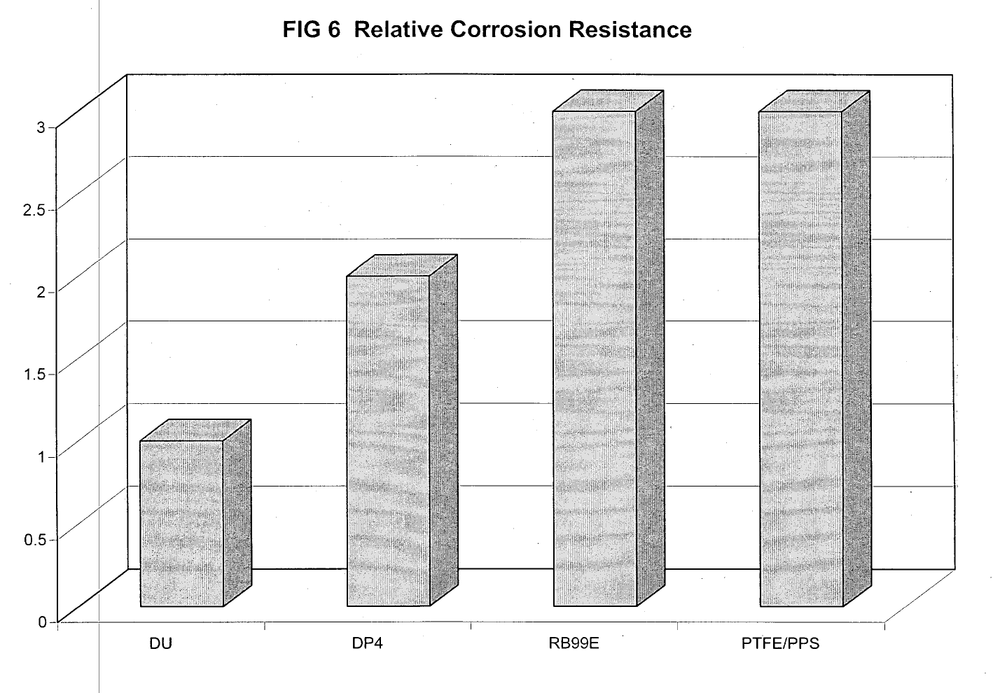

FIG. 6. shows the relative corrosion resistance of the material of the present invention (4) as well as three other well known bearing materials including DU, DP4, and RB99E. The PTFE/PPS blend of the present invention has excellent resistance to chemical attack, particularly from aggressive oils. It is particularly resistant to those oils containing sulfur additives or contaminates and can withstand exposure to high temperature oil (˜150° C.) for prolonged periods of time.

In summary, the material of the present invention, PTFE/PPS has a unique blend of properties of fatigue strength, lubricated wear resistance, corrosion resistance and friction that is superior to any of the prior bearing materials.

Thus it can be seen from the results that the material and method of the present invention provides a significant improvement in bearing properties over materials known in the art.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for the manufacture of a bearing material, the method comprising the steps of:
mixing an aqueous dispersion of polytetrafluoroethylene with about 10 to about 30 volume % of a polyarylene sulphide;
co-coagulating the PTFE and the PAS to form a powder;
removing excess water; at least partially drying the wet co-coagulated material to provide an at least partially dried powder material;
spreading said at least partially dried powder material particles onto a substrate to form a bearing material layer;
compacting said layer;
drying said compacted layer to drive off residual liquid; and,
sintering said dried, compacted layer at a temperature above the melting point of said PTFE constituent.

2. The method according to claim 1, wherein the substrate on which the at least partially dried powder material is spread is a metal strip having a porous layer into which the spread layer is impregnated.

3. The method according to claim 2 wherein the porous layer comprises bronze particles sintered to a metal backing.

4. The method according to claim 1, wherein the aqueous PTFE dispersion is in the form of unstabilised PTFE.

5. The method according to claim 1, wherein the polyarylene sulphide is present from about 15 to about 25 volume %.

6. The method according to claim 1, wherein the polyarylene sulphide comprises polyphenylene sulphide.

7. The method according to claim 6, wherein the aqueous dispersion of PTFE is mixed with about 20 volume % polyphenylene sulphide.

8. The method according to claim 1, wherein the polyarylene sulphide comprises two or more polyarylene sulphides.

9. The method according to claim 1, wherein the PTFE and polyarylene sulphide is further mixed with a further polymeric filler.

10. The method according to claim 1, where the polyarylene sulphide is replaced with a polymeric filler comprising at least one of PVDF, ECTFE, PEEK, PI, and PAI.

11. The method according to claim 1, wherein spreading the at least partially dried powder material onto a substrate to form the bearing material layer and compacting the layer further comprises extruding the mixture to form the layer configured as a monolithic tape or strip which is then dried and sintered.

12. The method according to claim 1, wherein the at least partially dried powder material has a further addition of a separate liquid lubricant material.

13. The method according to claim 1, wherein the wet coagulated material is substantially completely dried to form a powder.

14. The method according to claim 13 wherein the powder is mixed with a lubricant liquid prior to spreading onto the substrate.

15. The method according to claim 14 wherein the lubricant liquid is a hydrocarbon.

16. A plastics based bearing material obtainable by the method of claim 1, comprising a matrix of polytetrafluoroethylene having dispersed therein 10 to 30 volume % of a polyarylene sulphide.

17. A plastics based bearing material obtainable by the method of claim 16, wherein the polyarylene sulphide is polyphenylene sulphide.

18. A bearing having the bearing material of claim 16.

19. The bearing according to claim 16, wherein the bearing material is impregnated into a porous layer.

20. The bearing according to claim 16, wherein the porous layer comprises a layer of sintered bronze particles.

21. The bearing according to claim 16, wherein there is a layer of bearing material above the upper surface of the porous layer of between 25 and 100 μm.

22. A bearing material comprising PTFE and about 10 to about 30% polyarylene sulphide.

23. The bearing material of claim 22 wherein the polyarylene sulphide is polyphenylene sulphide.

24. A bearing comprising the bearing material of claim 22.
